(19) United States
(12) Patent Application Publication
(10) Pub. No.: US 2022/0013102 A1
(43) Pub. Date: Jan. 13, 2022

(54) SOUND-EMITTING DEVICE

(71) Applicant: Nippon Telegraph and Telephone Corporation, Tokyo (JP)

(72) Inventors: Sakurako Yazawa, Musashino-shi, Tokyo (JP); Kazunori Kobayashi, Musashino-shi, Tokyo (JP); Shoichiro Saito, Musashino-shi, Tokyo (JP)

(21) Appl. No.: 17/293,808

(22) PCT Filed: Nov. 7, 2019
(86) PCT No.: PCT/JP2019/043660

§ 371 Date: May 13, 2021

(30) Foreign Application Priority Data
Nov. 21, 2018 (JP) 2018-218650

(51) Int. Cl. G10K 11/28; H04R 1/02; H04R 1/34

(52) U.S. Cl. CPC G10K 11/28; H04R 2499/13; H04R 1/345; H04R 1/025

(57) ABSTRACT

There is provided a sound-emitting device that is easily installable and can output sound having directivity without performing signal processing. An on-vehicle sound-emitting device 10 installed in a vehicle includes a speaker 1 and a reflection unit 2 disposed at a position facing the speaker 1. The reflection unit 2 reflects sound output from the speaker 1 to direct the sound in a desired direction.

### TECHNICAL FIELD

The present invention relates to a sound-emitting device emitting sound in a desired direction.

### BACKGROUND ART

A signal processing technology to reproduce voice to a narrow range including a desired direction as viewed from a speaker has been conventionally studied and developed. Patent Literature 1 discloses a technology that performs signal processing by using transfer characteristics between a spot or a region where local reproduction is to be performed and a speaker array, to realize the local reproduction.

The relationship (sound pressure distribution) between surroundings of a speaker and sound pressure of sound output from the speaker is called directivity. Sharper directivity in a certain direction allows for reproduction of voice to a narrower range including the direction and suppression of sound pressure of the voice in a range other than the narrow range.

### CITATION LIST

### Patent Literature

Patent Literature 1: Japanese Patent Laid-Open No. 2012-147414

### SUMMARY OF THE INVENTION

### Technical Problem

In the technology disclosed in Patent Literature 1, it is necessary to prepare a large-scale speaker array, and to previously acquire the transfer characteristics between the speaker array and the spot where the local reproduction is to be performed. In other words, it is difficult to apply the technology disclosed in Patent Literature 1 to, for example, a case where the technology is used in a narrow space where the speaker array may not be installed, a case where the speaker array is carried and used in various places, and a case where the transfer characteristics are changed by for example the elapse of time or the like. In addition, in Patent Literature 1, previous acquisition of the transfer characteristics by an engineer is necessary as preparation in order to install the speaker array, which makes it difficult to install the speaker array.

The present invention is made in consideration of the above-described circumstances, and an object of the present invention is to provide a sound-emitting device that is easily installable and can output sound having directivity without performing signal processing.

### Means for Solving the Problem

To achieve the above-described object, according to an aspect of the present invention, an on-vehicle sound-emitting device installed in a vehicle includes a speaker and a reflection unit disposed at a position facing the speaker. The reflection unit reflects sound output from the speaker to direct the sound in a desired direction.

### Effects of the Invention

According to the present invention, it is possible to provide a sound-emitting device that is easily installable and can output sound having directivity without performing signal processing.

### BRIEF DESCRIPTION OF DRAWINGS

FIG. 1A is a side view schematically illustrating a configuration of a sound-emitting device according to an embodiment of the present invention.

FIG. 1B is a top view schematically illustrating the configuration of the sound-emitting device according to the embodiment of the present invention.

FIG. 2A is a perspective view of a reflection unit and a holding unit.

FIG. 2B is a side view of the reflection unit and the holding unit.

FIG. 2C is a top view of the reflection unit and the holding unit.

FIG. 2D is a front view of the reflection unit and the holding unit.

FIG. 3 is an explanatory diagram to explain reflection of sound.

FIG. 4 is a diagram illustrating a sound emission range in a case where paired sound-emitting devices are used.

FIG. 5 is a diagram illustrating an example in which the paired sound-emitting devices are installed on a seat in a vehicle.

FIG. 6 is a diagram illustrating an example in which the paired sound-emitting devices are installed on each of a driver seat and a front passenger seat.

FIG. 7A is a perspective view of a reflection unit and a holding unit according to a modification 1.

FIG. 7B is a side view of the reflection unit and the holding unit according to the modification 1.

FIG. 7C is a top view of the reflection unit and the holding unit according to the modification 1.

FIG. 7D is a front view of the reflection unit and the holding unit according to the modification 1.

FIG. 8A is a perspective view of a reflection unit and a holding unit according to a modification 2.

FIG. 8B is a side view of the reflection unit and the holding unit according to the modification 2.

FIG. 8C is a top view of the reflection unit and the holding unit according to the modification 2.

FIG. 8D is a front view of the reflection unit and the holding unit according to the modification 2.

FIG. 9A is a perspective view of a reflection unit according to a modification 3.

FIG. 9B is a side view of the reflection unit according to the modification 3.

FIG. 9C is a top view of the reflection unit according to the modification 3.

FIG. 9D is a front view of the reflection unit according to the modification 3.

FIG. 10 is an explanatory diagram to explain reflection of sound according to the modification 3.

### DESCRIPTION OF EMBODIMENTS

An embodiment of the present invention will be described below with reference to drawings.

A sound-emitting device according to the present embodiment is an on-vehicle sound-emitting device mounted on a vehicle. The present invention, however, is not limited thereto.

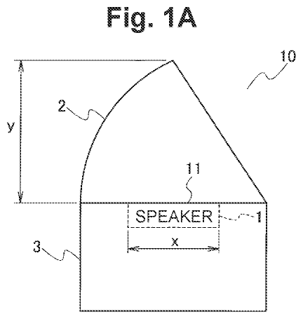

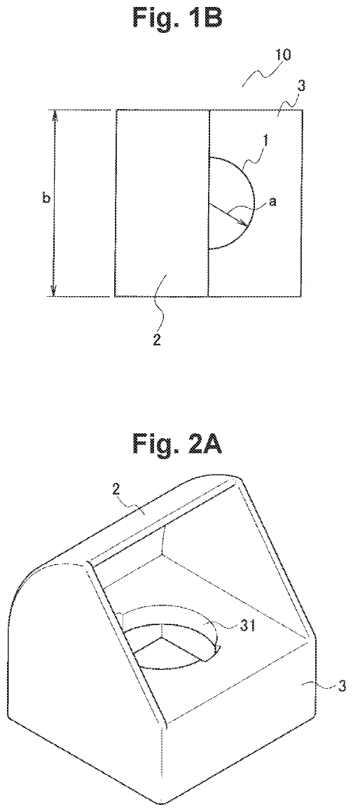

FIG. 1A and FIG. 1B are configuration diagrams schematically illustrating a configuration and appearance of a sound-emitting device 10 according to the present embodiment. FIG. 1A is a side view of the sound-emitting device 10 as viewed from side. FIG. 1B is a top view of the sound-emitting device 10 as viewed from above.

The illustrated sound-emitting device 10 includes a speaker 1 (a speaker unit), a reflection unit 2, and a holding unit 3.

The speaker 1 is a device that converts an electric signal that is an input from an unillustrated external device into a sound wave (hereinafter, referred to as “sound”), and outputs the sound. The speaker 1 is held by the holding unit 3, and is disposed (attached) inside the sound-emitting device 10. In the speaker 1 according to the present embodiment, a sound emission surface 11 through which the sound is emitted has a circular shape, but the shape of the sound emission surface 11 is not limited thereto. Further, “sound” (voice) includes not only voice of human and animal but also the whole of “sound” such as musical sound and ambient noise.

The reflection unit 2 is disposed at a position facing the speaker 1, and reflects the sound output from the speaker 1 to direct the sound in a desired direction. More specifically, the reflection unit 2 is a cover (outer shell) that is disposed at the position facing (above in illustrated example) the speaker 1 and covers the sound emission surface 11 of the speaker 1 disposed (enclosed) inside the reflection unit 2. In addition, the reflection unit 2 opens toward a direction (desired direction) in which the sound of the speaker 1 is directed.

The reflection unit 2 illustrated in FIG. 1A and FIG. 1B has a curved surface curved in an arc shape having a length equal to a length of one side of the holding unit 3. The curved surface has a recessed surface on a surface side facing the speaker 1. Further, the arc-shaped reflection unit 2 has a size of covering at least about half of the sound emission surface 11 of the speaker 1.

Out of the sound emitted from the speaker 1, sound emitted toward the reflection unit 2 in a direction different from the desired direction is reflected (refracted) by the curved surface of the reflection unit 2, and is emitted in the desired direction. As a result, in the present embodiment, it is possible to direct the sound output from the speaker 1 in the desired direction, and to emit the sound to a narrow range including the desired direction. In other words, the reflection unit 2 is a member disposed and formed such that the reflected sound that has been output from the speaker 1 and reflected once by the reflection unit 2 has narrow directivity.

The holding unit 3 is a housing for holding the speaker 1, and internally has a cavity for incorporating the speaker 1. The holding unit 3 according to the present embodiment has a rectangular parallelepiped shape, but the shape of the holding unit 3 is not limited thereto.

Note that a distance between the speaker 1 and the reflection unit 2 is desirably less than or equal to three times the size of the speaker 1. More specifically, as illustrated in FIG. 1A, the distance between the speaker 1 and the reflection unit 2 corresponds to a height y of the reflection unit 2. Further, the size of the speaker 1 corresponds to a diameter x of the speaker 1 (sound emission surface 11). In this case, it is desirable to satisfy y≤3x. This is because, if the reflection unit 2 is excessively large, targeted reflection (intended reflection) may not be achieved. In other words, this is because, if the reflection unit 2 is excessively large, sound pressure for performing the targeted reflection in the desired target direction is reduced (energy is reduced), and, therefore, a sound volume is lowered even if the reflection can be performed, and, as a result, the sound may not be directed. Further, as illustrated in FIG. 1B, if it is assumed that the speaker 1 has a radius a, a length b of one side of the holding unit 3 is desirably less than three times the radius a (b<3a). Thus, by using the small speaker 1 of about several cm, it is possible to downsize the whole of the sound-emitting device 10.

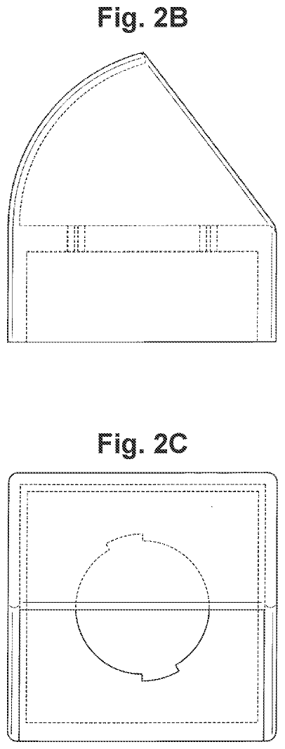

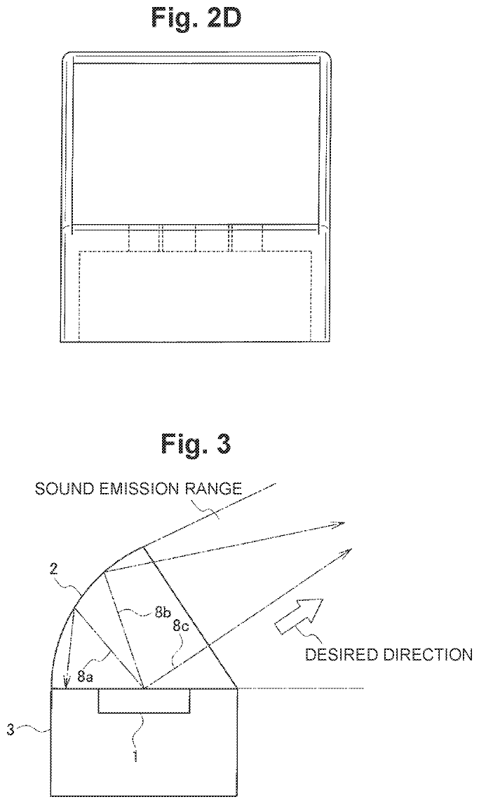

FIG. 2A to FIG. 2D are diagrams illustrating an example of the reflection unit 2 and the holding unit 3 described with reference to FIGS. 1A and 1B. FIG. 2A is a perspective view, FIG. 2B is a side view, FIG. 2C is a top view, and FIG. 2D is a front view. The holding unit 3 includes an opening 31 to expose the sound emission surface of the speaker 1. Note that, in FIG. 2A to FIG. 2D, the reflection unit 2 and the holding unit 3 are integrated, but the reflection unit 2 and the holding unit 3 may be separated parts to be combined.

In the illustrated example, the opening 31 of the holding unit 3 includes two convex portions for holding the speaker 1, but the convex portions may not be provided. The opening 31 is formed corresponding to the shape of the speaker 1 to be fitted in the holding unit 3, and the shape of the opening 31 is not limited to the illustrated shape.

FIG. 3 is an explanatory diagram to explain reflection of the sound output from the speaker 1 according to the present embodiment. The desired direction is a direction to which the reflection unit 2 opens. The speaker 1 emits the sound in all directions (all upper directions in illustrated example) facing the sound emission surface 11, but the sound-emitting device 10 according to the present embodiment directs the sound in the desired direction by reflecting the sound on the reflection unit 2. In other words, the sound output from the speaker 1 is not emitted in a direction largely different from the desired direction by being reflected by the reflection unit 2. Accordingly, in the present embodiment, it is possible to direct the sound to the narrow range (region) including the desired direction.

In the illustrated example, sound 8a that is output from the speaker 1 toward the reflection unit 2 at a relatively small elevation angle to the sound emission surface 11 of the speaker 1 is reflected (refracted) in a direction of the holding unit 3 by colliding with the reflection unit 2, and is less likely to be emitted to the outside of the sound-emitting device 10. Sound 8b that is output toward the reflection unit 2 at a relatively large elevation angle to the sound emission surface 11 of the speaker 1 is reflected (refracted) toward the desired direction by colliding with the reflection unit 2. Sound 8c that is output from the speaker 1 toward the desired direction is emitted as it is in the desired direction. In FIG. 3, the reflected sound reflected once by the reflection unit 2 (reflected sound generated by single reflection) is directed in a desired direction 9. The number of reflections performed by the reflection unit 2 is not limited to one, and may be more than one.

As described above, in the present embodiment, the reflection unit 2 opening toward the desired direction, namely, the reflection unit 2 disposed on a side opposite to the desired direction is provided, and the reflection unit 2 reflects the sound output from the speaker 1 toward a direction different from the desired direction, to prevent the sound from being emitted in the direction different from the desired direction. As a result, in the present embodiment, it is possible to direct the sound output from the speaker 1 to the narrow range including the desired direction 9.

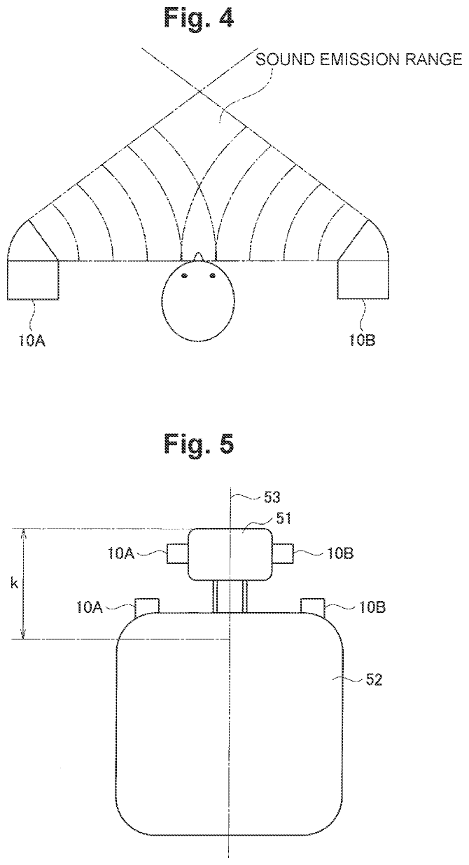

FIG. 4 is a diagram illustrating a sound emission range in a case where two sound-emitting devices 10 according to the present embodiment are used as a pair (set). In the illustrated example, sound is reproduced in a stereo mode by using paired sound-emitting devices 10A and 10B respectively disposed on a left side and a right side of a user. In this case, the sound emission range formed by the paired sound-emitting devices 10A and 10B has a substantially triangular shape having a vertex located in front of the user. In other words, the sound-emitting devices 10A and 10B direct the sound to the front of the user.

FIG. 5 is a diagram illustrating an example in which the paired sound-emitting devices 10A and 10B are installed on a seat in a vehicle. The sound-emitting devices 10A and 10B are symmetrically installed on a headrest 51 of the seat or an upper portion of a backrest 52 of the seat so as to be positioned at a height of ears of the user (height within illustrated range k). More specifically, the sound-emitting devices 10A and 10B are installed on both sides (both ends) of the headrest 51 of the seat. Alternatively, the sound-emitting devices 10A and 10B are installed on the upper portion of the backrest 52 of the seat. In addition, the paired sound-emitting devices 10A and 10B are disposed at positions line-symmetrical about a center line 53 of the headrest 51 and the backrest 52.

Each of the paired sound-emitting devices 10A and 10B disposed as described above emits sound toward the ears of the user sitting on the seat. The sound emission range formed by the paired sound-emitting devices 10A and 10B is in front of the user as illustrated in FIG. 4. As a result, even the user is inside the vehicle where noise and undesired sound are assumed, it is possible to deliver the sound reproduced by the speaker 1 to the ears of the user sitting on the seat.

Further, in a case where the sound-emitting devices 10A and 10B are installed on (headrest 51 or backrest 52 of) a driver seat or a front passenger seat, the sound-emitting devices 10A and 10B are not supposed to obstruct visual field and hinder driving. Accordingly, the sound-emitting devices 10A and 10B, each desirably have a small size so as not to obstruct the visual field are desirable.

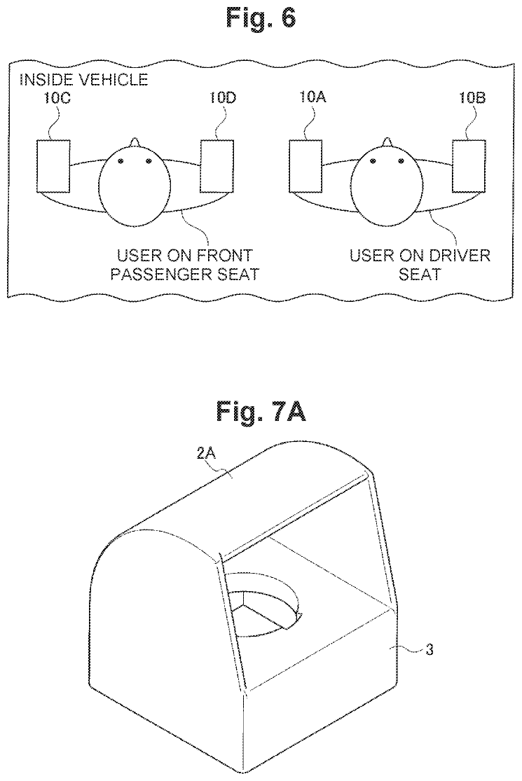

FIG. 6 is a diagram schematically illustrating an example in which paired sound-emitting devices are installed on each of a driver seat and a front passenger seat in a vehicle. The paired sound-emitting devices 10A and 10B are installed on the driver seat, and paired sound-emitting devices 10C and 10D are installed on the front passenger seat. In this case, the sound emission range of the paired sound-emitting devices 10A and 10B installed on the driver seat has a substantially triangular shape having a vertex located in front of the user on the driver seat as illustrated in FIG. 4. In other words, the sound-emitting devices 10A and 10B direct the sound to the front of the user on the driver seat. In addition, a sound emission range of the paired sound-emitting devices 10C and 10D installed on the front passenger seat also has a substantially triangular shape having a vertex located in front of the user on the front passenger seat as illustrated in FIG. 4. In other words, the sound-emitting devices 10C and 10D direct the sound to the front of the user on the front passenger seat.

Accordingly, the two sound-emitting devices 10A and 10D adjacent to each other direct the sound output from the respective speakers 1 to directions different from each other by the respective reflection units 2 of the sound-emitting devices 10A and 10D. This makes it possible to prevent interference of the sound of the sound-emitting devices 10A and 10D adjacent to each other. As described above, the paired sound-emitting devices 10A and 10B (10C and 10D) according to the present embodiment do not emit the sound toward the adjacent seat.

As a result, for example, in a case where the user sitting on the driver seat or the front passenger seat talks with the user sitting on a rear seat by using the paired sound-emitting devices 10A and 10B (10C and 10D), only the user sitting on the target seat can hear voice of the user sitting on the rear seat through the paired sound-emitting devices.

Note that, among the paired sound-emitting devices 10A and 10B on the driver seat and the paired sound-emitting devices 10C and 10D on the front passenger seat, the sound-emitting devices 10B and 10C on both ends (sound-emitting device 10B on window side of driver seat and sound-emitting device 10C on window side of front passenger seat) are adjusted so as to output the sound at a volume not reaching the opposite side.

In the case where the sound-emitting devices 10A and 10B are installed on the driver seat of the vehicle, the sound-emitting devices 10A and 10B are not required to have excessively sharp directivity because the driver performs operation such as confirmation of outside of the window during driving.

Note that the case where the paired sound-emitting devices are installed on the seat in the vehicle to reproduce the sound in the stereo mode has been described with reference to FIG. 6, but the sound may be directed to the ears of the user sitting on the seat by using one sound-emitting device 10. Alternatively, the paired sound-emitting devices may be disposed, and the same sound may be reproduced from both of the sound-emitting devices (sound-emitting devices are paired but reproduction is performed in monaural mode).

Although the reflection unit 2 according to the present embodiment described above has the arc-shaped curved surface, the reflection unit 2 is not limited thereto. In the following, modifications of the reflection unit 2 will be described. Note that the reflection unit in each of the modifications configures the sound-emitting device by being used together with the speaker 1 and the holding unit 3 similar to those in the present embodiment.

### Modification 1

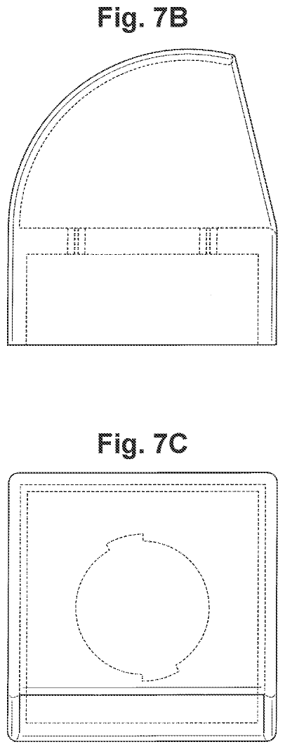

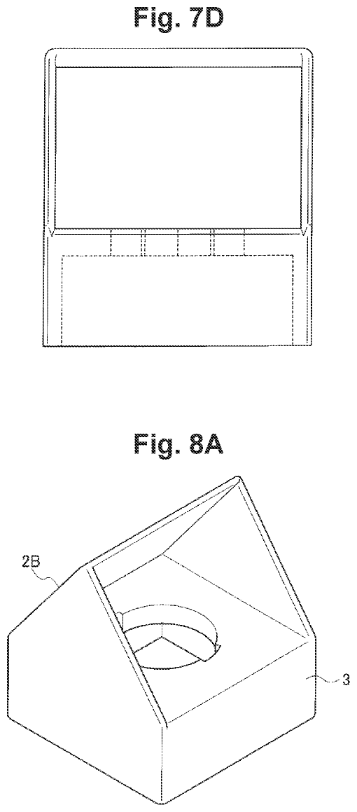

FIG. 7A to FIG. 7D are diagrams illustrating a reflection unit 2A and the holding unit 3 according to a modification 1. FIG. 7A is a perspective view, FIG. 7B is a side view, FIG. 7C is a top view, and FIG. 7D is a front view. Note that, in FIG. 7A to FIG. 7D, the reflection unit 2A and the holding unit 3 are integrated, but the reflection unit 2A and the holding unit 3 may be separated parts to be combined.

The reflection unit 2A according to the modification 1 has a curved surface curved in an arc shape having a length equal to a length of one side of the holding unit 3, as with the reflection unit 2 according to the present embodiment. The reflection unit 2 according to the present embodiment has the size of covering at least about half of the sound emission surface 11 of the speaker 1, whereas the reflection unit 2A according to the modification 1 has a size of covering substantially the whole of the sound emission surface of the speaker 1 by extending the arc-shaped curved surface of the reflection unit 2A.

Thus, the sound-emitting device using the reflection unit 2A according to the modification 1 can emit the sound output from the speaker 1 to a narrower range as compared with the sound-emitting device 10 using the reflection unit 2 according to the present embodiment. In other words, the sound-emitting device using the reflection unit 2A according to the modification 1 can give narrower directivity to the sound output from the speaker 1.

### Modification 2

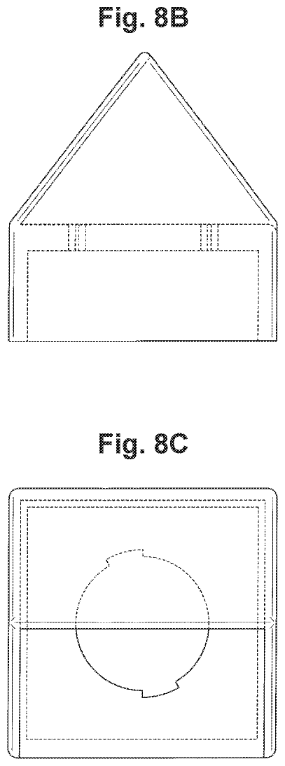

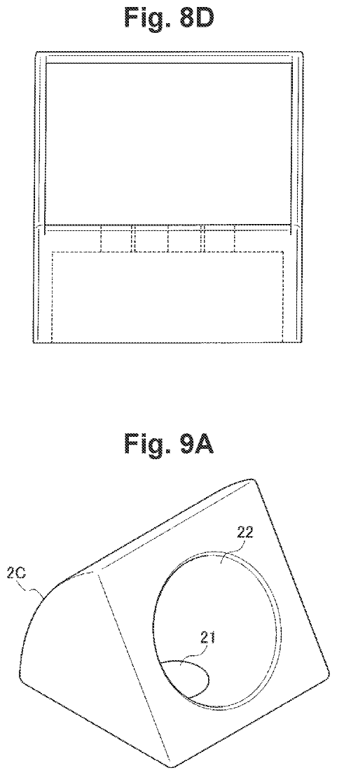

FIG. 8A to FIG. 8D are diagrams illustrating a reflection unit 2B and the holding unit 3 according to a modification 2. FIG. 8A is a perspective view, FIG. 8B is a side view, FIG. 8C is a top view, and FIG. 8D is a front view. Note that, in FIG. 8A to FIG. 8D, the reflection unit 2B and the holding unit 3 are integrated, but the reflection unit 2B and the holding unit 3 may be separated parts to be combined.

The reflection unit 2B according to the modification 2 has a flat surface having a length equal to a length of one side of the holding unit 3. The reflection unit 2 according to the modification 2 has a size of covering at least about half of the sound emission surface 11 of the speaker 1. A sound-emitting device using the reflection unit 2B according to the modification 2 can emit the sound output from the speaker 1 to a narrow range including a desired direction by reflecting the sound by the reflection unit 2, as with the sound-emitting device 10 according to the present embodiment.

### Modification 3

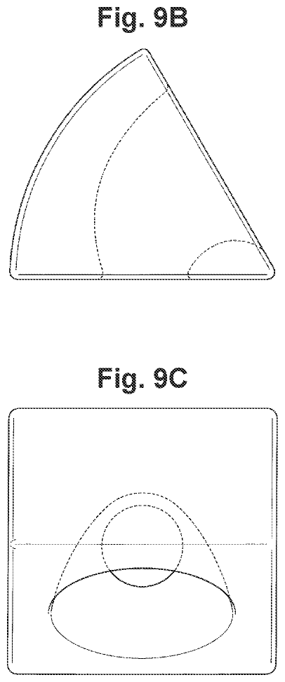

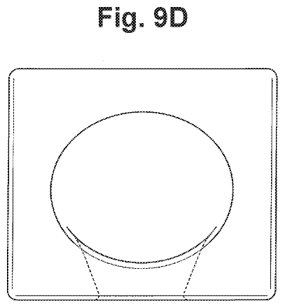

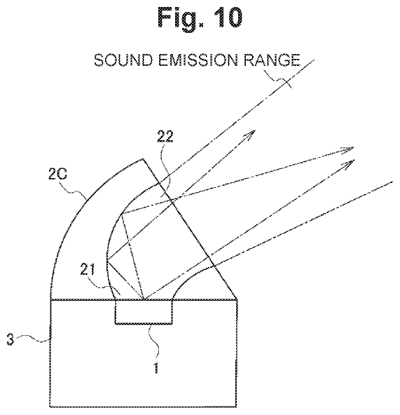

FIG. 9A to FIG. 9D are diagrams illustrating a reflection unit 2C according to a modification 3. FIG. 9A is a perspective view, FIG. 9B is a side view, FIG. 9C is a top view, and FIG. 9D is a front view. FIG. 10 is a cross-sectional view of the reflection unit 2C according to the modification 3. The reflection unit 2C according to the modification 3 configures the sound-emitting device by being used together with the speaker 1 and the holding unit 3 similar to those in the present embodiment.

The reflection unit 2C according to the modification 3 includes a horn-shaped cylindrical member. More specifically, the reflection unit 2C includes the cylindrical member that includes a first opening 21 opening on a side of the speaker 1 and a second opening 22 opening in the desired direction. In addition, as illustrated in FIG. 9A to FIG. 9D, the cylindrical member is curved. More specifically, the cylindrical member is continuously curved from the first opening 21 toward the second opening 22. As a result, a plurality of times of reflections inside the cylindrical member can be prevented, and sound emission to a direction other than the desired direction can be eliminated to improve efficiency of reflection, which makes it possible to direct the sound output from the speaker 1 in the desired direction.

Further, in the illustrated example, the second opening 22 of the cylindrical member is larger than the first opening 21. As illustrated in FIG. 10, a cross-sectional shape of a curved portion has a curved surface causing the shape to be gradually increased from the first opening 21 side toward the second opening 22 side. The first opening 21 has a diameter equal to the diameter of the speaker 1 to be installed. If a diameter of the second opening 22 and the diameter of the first opening 21 are made equal to each other (diameter of second opening 22 is made small), sound energy to be emitted is reduced. In addition, making the second opening 22 larger than the first opening 21 makes it possible to avoid extremely sharp directivity.

FIG. 10 is an explanatory diagram to explain reflection of the sound output from the speaker 1 of the sound-emitting device using the reflection unit 2C. The desired direction is a direction in which the second opening 22 of the reflection unit 2C opens. The speaker 1 emits the sound in all directions (all upper directions in illustrated example) facing the sound emission surface 11. However, in the present embodiment, since the speaker 1 is connected to the first opening 21 of the reflection unit 2C, the sound output from the speaker 1 is efficiently reflected inside the curved cylindrical member, and is directed in the desired direction. In other words, as compared with the reflection unit 2 (FIG. 3) according to the present embodiment, the reflection unit 2C according to the modification 3 can reduce useless reflection in a direction different from the desired direction.

The sound-emitting device according to the present embodiment including the modifications described above includes the speaker 1 and the reflection unit 2 disposed at the position facing the speaker 1, and the reflection unit 2 reflects the sound output from the speaker 1 to direct the sound in the desired direction. Thus, according to the present embodiment, it is possible to provide the sound-emitting device that is easily installable and can output sound having directivity without performing signal processing.

In other words, in the present embodiment, it is possible to achieve emission of the sound having narrow directivity for causing sound to be directed to the narrow range including the desired direction without performing complicated signal processing.

Further, in the present embodiment, the nondirectional speaker 1 is usable, which is advantageous in cost.

Furthermore, in the present embodiment, even in a case where the transfer characteristics are changed by, for example, the elapse of time or the like, it is possible to output the sound having directivity. For example, inside the vehicle, the transfer characteristics may be changed due to opening/closing of a window, or the like. Even in such a case, it is possible to output the sound having directivity in the present embodiment.

Further, the sound-emitting device 10 according to the present embodiment has a simple configuration including the speaker 1 and the reflection unit 2. In other words, the sound-emitting device 10 according to the present embodiment can give directivity with the small number of parts. This makes it possible to provide the sound-emitting device 10 that is easy in manufacturing and low in cost.

Further, the sound-emitting device 10 according to the present embodiment can be easily downsized because of the simple configuration. Therefore, the sound-emitting device 10 is easily installed in a narrow place such as the inside of the vehicle, and is easily carried. Further, since the sound-emitting device 10 according to the present embodiment has the simple configuration, preparation for installation in advance is unnecessary and a general user can easily install the sound-emitting device 10.

Note that the present invention is not limited to the above-described embodiment and modifications, and various modifications can be made within the scope of the gist.

### REFERENCE SIGNS LIST

1 Speaker
2 Reflection unit
21 First opening
22 Second opening
3 Holding unit
31 Opening
10, 10A, 10B, 10C, 10D Sound-emitting device
51 Headrest
52 Backrest

1. An on-vehicle sound-emitting device configured to be installed in a vehicle, the sound emitting device comprising:
a speaker; and
a reflection unit disposed at a position facing the speaker, the reflection unit configured to reflect sound output from the speaker to direct the sound in a desired direction.

2. The sound-emitting device according to claim 1, wherein the reflection unit comprises an arc-shaped curved surface.

3. The sound-emitting device according to claim 1, wherein the reflection unit comprises a flat surface.

4. The sound-emitting device according to claim 1, wherein the reflection unit comprises a cylindrical member including a first opening that opens on a side of the speaker and a second opening that opens toward the desired direction.

5. The sound-emitting device according to claim 4, wherein the cylindrical member is curved.

6. The sound-emitting device according to claim 1, wherein a height of the reflection unit is equal to or less than three times the size of the speaker.

7. A sound-emitting device comprising two sound-emitting devices according to claim 1 as a pair, wherein the paired sound-emitting devices are configured to be installed on a headrest of a seat or an upper portion of a backrest of the seat.

8. A sound-emitting device, comprising:
a speaker; and
a reflection unit disposed at a position facing the speaker, the reflection unit configured to reflect sound output from the speaker to direct the sound in a desired direction.
